(19) United States
(12) Patent Application Publication
(10) Pub. No.: US 2003/0069862 A1
(43) Pub. Date: Apr. 10, 2003

(54) System for preparing mail items

(75) Inventor: Pascal Charroppin, Le Vesinet (FR)

Correspondence Address: SUGHRUE, MION, ZINN, MACPEAK & SEAS, PLLC, 2100 Pennsylvania Avenue N.W., Washington, DC, 20037-3202, US

(73) Assignee: NEOPOST INDUSTRIE

(21) Appl. No.: 10/265,273

(22) Filed: Oct. 7, 2002

(30) Foreign Application Priority Data
Oct. 5, 2001 (FR) 01 12819

(51) Int. Cl. G06F 17/00

(52) U.S. Cl. 705/408; 705/401

(57) ABSTRACT

The present invention relates to a system for preparing mail items comprising both postal indicia and a service marking representative of a service associated with this mail item and previously requested by a user, this system comprising first standard print means connected to a computer terminal of the user itself linked, through an Internet network, to a server housing the website of a third party in charge of preparing the mail items, in order to print both the postal coordinates of the addressee and the service marking. Second secured print means constituted by a franking machine are further provided to print the postal indicia.

### FIELD OF THE INVENTION

The present invention relates exclusively to the domain of mail handling and concerns more particularly a system and a process for preparing mail items, such as letters or parcels, in relation with a determined service.

### BACKGROUND OF THE INVENTION

British Patent No. 2 055 699 to POSTALIA discloses means for printing postal indicia allowing the inscription of markings serving to differentiate the mail items by their category (letter, parcel, printed matter, registered letter, etc . . . ). This function of specific marking is also present in European Patent Application EP 0 878 778 to PITNEY BOWES which applies it to modem franking devices linked to a computer. According to the architecture described in FIG. 5 of that Application, the franking machine 52 prints both the postal imprint 14 and a specific marking 33, a standard printer 60 linked to this computer ensuring print of a receipt or acknowledgement of receipt 61 bearing characteristic data of the franked mail item 11. The user's computer 50 directly linked to the franking machine is in communication both with a postal server 70 and a server 65 of the manufacturer of the franking machine.

In order to be able to ensure simultaneous reception of a plurality of communications coming from different users, the “postal” and “manufacturer” servers are each provided at the input with a bank of modem(s) of which the number corresponds to the desired number of communications that may be received simultaneously by the server.

However, such system architecture presents numerous drawbacks, particularly associated with its cost. In effect, the multiplicity of modems renders this architecture particularly expensive if it is desired that the connections with the users not be made in too long, and even prohibitive, a response time. But, in particular, this architecture cannot be conceived without the employment of franking machines linked with a computer of the user. In effect, without such link, no specific marking can exist. Now, at the present time, in France alone, for example, there exists a park of more than 100 000 electromechanical machines bereft of any functions of communication and which are therefore automatically excluded from the functionalities of specific marking associated with a determined service proposed to the user by the said architecture. Moreover, the postal indicia being a monetary value, any error in the print of the afore-mentioned marking (which will therefore not be able to be accepted by the Postal Service despite valid postal indicia having no defect in quality) will bring about a loss for the user which is all the greater as the corresponding service is subjected to a high amount of franking with respect to that relative to traditional mail not having such a specific service.

It is therefore an object of the present invention to overcome these drawbacks by proposing a system and process for preparing mail items intended for all types of franking machines including, and especially, those which do not present means of communication. One object of the invention is to propose a system and process which is indifferent to possible errors in the marking of the service. Another object of the invention is also to propose a process which may be carried out around a system architecture which is both simple and inexpensive.

### SUMMARY OF THE INVENTION

These objects are attained by a system for preparing mail items comprising both postal indicia and a service marking representative of a service associated with this mail item and previously requested by a user of this system, system characterized in that it comprises first standard print means for printing the service marking and second secured print means for printing the postal indicia.

This independent print of the postal indicia, which has a monetary value, and of the service marking, which does not, avoids any financial loss for the user in the event of errors in the marking. In addition, it promotes separate use at different places, the printing of the service marking being effected in each office when the document to be dispatched is produced, while that of the postal indicia may be centralized in a mailing department.

Said first standard print means are constituted by a standard printer connected to a computer terminal linked, through an Internet network, to a server housing the website of an identified third party in charge of preparing the mail items (preferably a distributor of franking machines), and the second secured print means are constituted by a franking machine linked to a server of the distributor of said franking machine via a specialized line of communication.

The computer terminal comprises data collecting means in order to enter determined information relative to the mail item benefitting from the service requested, and in particular the postal coordinates of the addressee of this mail item.

The server comprises means for attributing a unique sequential number to the mail item benefitting from the service requested as a function of said determined information collected at said computer terminal.

The system for preparing mail items according to the invention further comprises data storage means shifted to the level of said server to memorize said determined information collected at said computer terminal and said unique sequential number attributed by said server, these storage means being accessible from said computer terminal and from a server of the Postal Service. These storage means comprise means for memorizing determined data relative to the delivery of the mail item by the Postal Service and received from said Postal Service server.

The present invention also relates to the system for preparing mail items in which both the printing of the postal coordinates of the addressee and the service marking are effected by first standard print means linked to a computer terminal of a user itself linked, through an Internet network, to a server housing the website of a third party in charge of preparing the mail items.

The present invention also relates to the process for preparing mail items carried out in one or the other of the two afore-mentioned systems and comprising in particular the following steps:

a) establishment of a link with the Internet network from a computer terminal of a user,

b) access to a server housing the website of an identified third party in charge of preparing the mail items,

c) consultation at the user's computer terminal of a general presentation page of said website of the identified third party relative to said service,

d) upon first access to said service, supply by said server of the identified third party of a user name and a password in exchange for the communication by the user of determined information,

e) during subsequent accesses to said service, entry in the user's computer terminal of the user name and password received upon said first access,

f) display at the user's computer terminal of a personal presentation page relative to said service and specific to the user,

g) selection at the user's computer terminal of a postal product proposed on said personal presentation page from those of the group including the traceable letter, the traceable registered letter and traceable registered letter with return receipt,

h) display at the user's computer terminal of an entry screen relative to the postal product selected,

i) entry at the user's computer terminal of determined information necessary for dispatching a mail item,

j) attribution by the server of the identified third party of a unique sequential number associated with the mail item to be dispatched, and

k) printing, by a standard printer linked to said computer terminal, of the service marking incorporating said unique sequential number and an identifier of the postal product selected.

This process may further include a step of franking the mail item which consists in printing the postal indicia by a franking machine, and the step of access to the website of the identified third party, preferably that of a franking machine distributor, may be effected via a website of the Postal Service.

### BRIEF DESCRIPTION OF THE DRAWINGS

The invention will be more readily understood on reading the following description given by way of non-limiting indication, with reference to the accompanying drawings, in which:

FIGS. 1A and 1B show two examples of data-processing architecture for carrying out the process of preparing mail items according to the invention.

FIG. 2 illustrates the different steps of the procedure of dispatching the mail items in accordance with the process of the invention, and

FIGS. 3 and 4 show two examples of mail items obtained by the process of the invention.

### DESCRIPTION OF PREFERRED EMBODIMENT

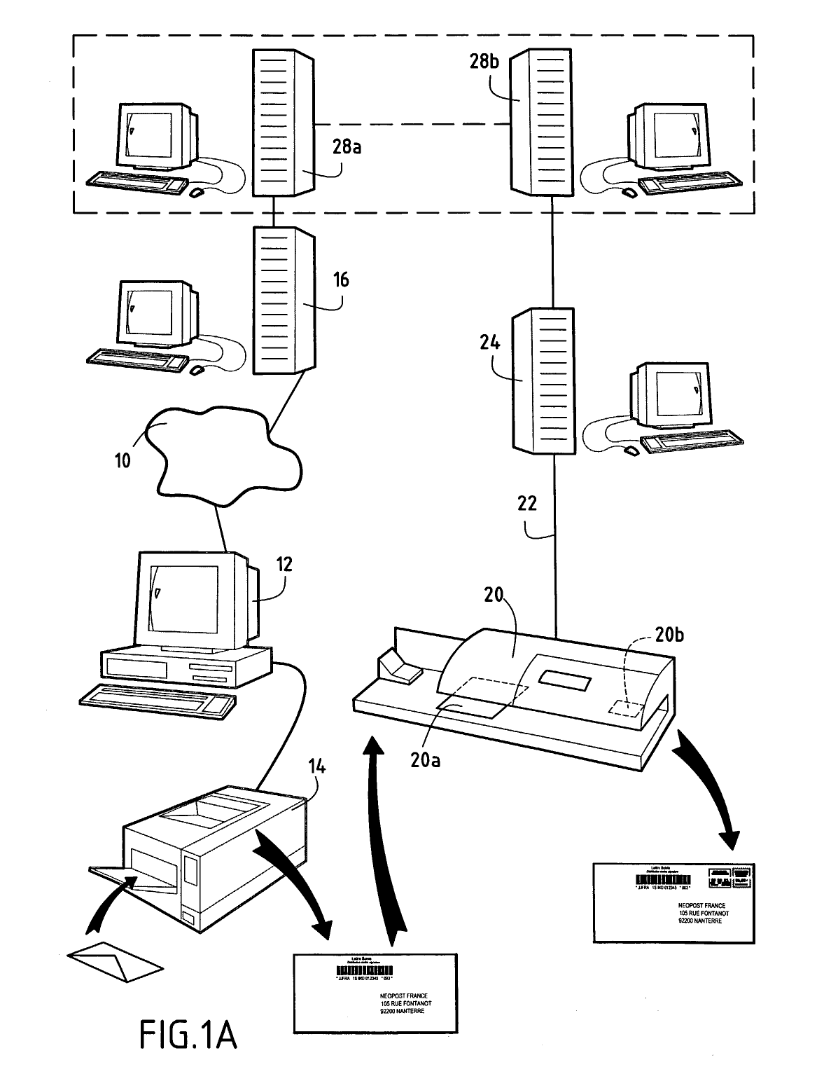

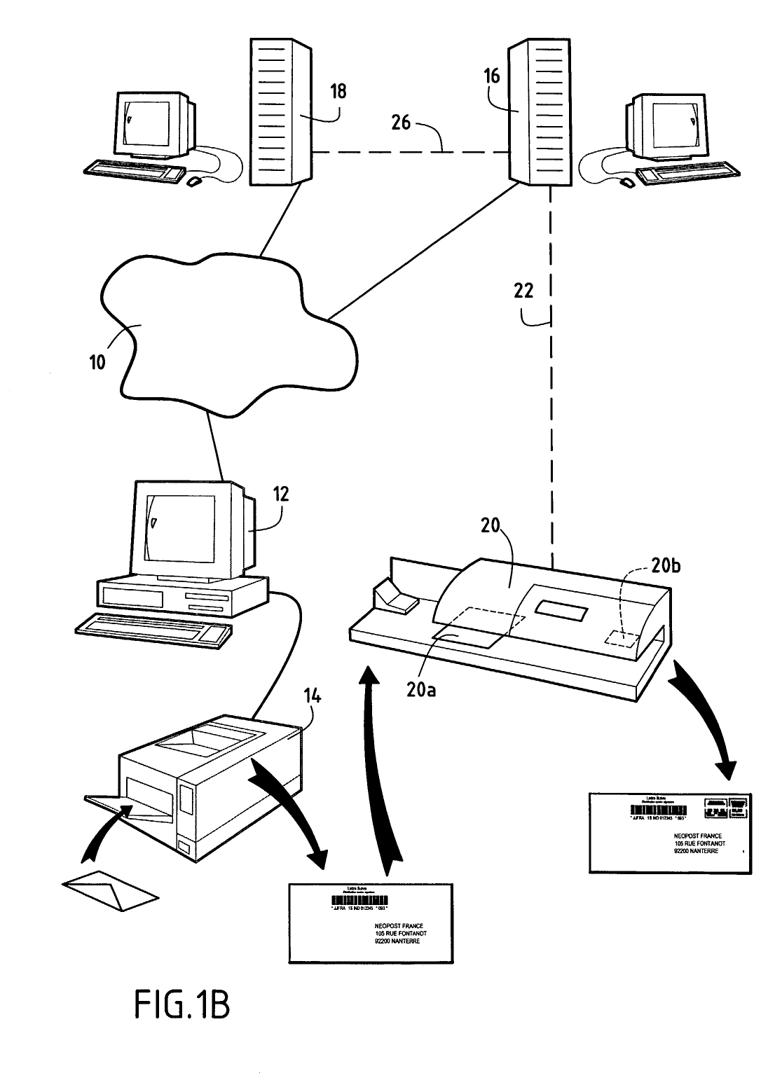

Referring now to the drawings, FIGS. 1A and 1B illustrate two examples of data-processing architecture allowing a user to carry out the process according to the invention for preparing mail items.

These two data-processing architectures are organized around the worldwide computer communication network 10 known as the “Internet” network, and to which is linked at least one computer terminal 12 of a user. The user s computer terminal is preferably a conventional personal computer to which is linked a printer 14 of standard type, with laser, thermal or inkjet print for example. However, any data-processing terminal provided with an Internet navigator and capable of controlling print on a printer may advantageously replace such a conventional personal computer. This is the case for example of a personal digital assistant (PDA) provided with short distance radio communication means (in accordance with IEEE standard 802-11b or of Bluetooth type for example) for remotely controlling the printer 14 and provided with mobile radio communication means (of GPRS or UMTS type for example) for link to the Internet network 10.

In the architecture illustrated in FIG. 1A, the user's terminal 12 is linked through the network 10 to a server 16 of a third party in charge of preparing the mail items. In the one illustrated in FIG. 1B, the user's terminal is also linked to a server 18 of a Postal Service through the network 10. In addition, in this variant, the identified third party is preferably a manufacturer or distributor of franking machines.

In addition, the user has available a franking machine 20 preferably comprising integrated postal scales 20a (but a link with outside scales may be envisaged), intended to print postal indicia on mail items or labels introduced in this machine. This franking machine may be a conventional electromechanical machine, not linked to a communication network (i.e. without internal interface for communication and without possibility of any outside interfacing) or possibly a modern electronic machine provided with means for communication with a server of the distributor or manufacturer of the machine, through a secured specialized communication line 22. This distributor server may be a server 24 especially dedicated to a function of communication of postal data (particularly reloading data) as illustrated in FIG. 1A, or may be the mail preparation server 16 linked to the Internet network (case of FIG. 1B). In this second configuration, the distributor server 16 is preferably linked to the Postal Service server 18 likewise by a secured specialized communication line 26. On the contrary, in the first configuration, the mail preparation server 16 and the dedicated server of the distributor 24 are each linked to a distinct Postal Service server 28a, 28b (and in that case optionally linked together), or not. However, an architecture with a unique server (not shown) performing both the functions of the distributor server for preparing mail and the functions of the Postal Service server, may, of course, also be envisaged.

The franking machine may further comprise integrated digital image acquisition means 20b for automatically collecting and reading graphic data printed on the mail items or the labels, such as those described in the Application filed by Applicants concomitantly with the present Application and entitled: “Franking machine provided with a device monitoring conformity of the postal indicia”.

It will be recalled that, in a traditional machine, the user makes a daily manual statement (on appropriate forms addressed each month to the Postal Service) of the frankings made (checking of the ascending and descending registers) and the franking credit is reloaded by returning the franking machine (preferably only a secured part thereof) to the Postal Service. On the contrary, in a modern machine, such reloading, like the daily statement of the frankings, is effected remotely through the afore-mentioned secured specialized communication line 22.

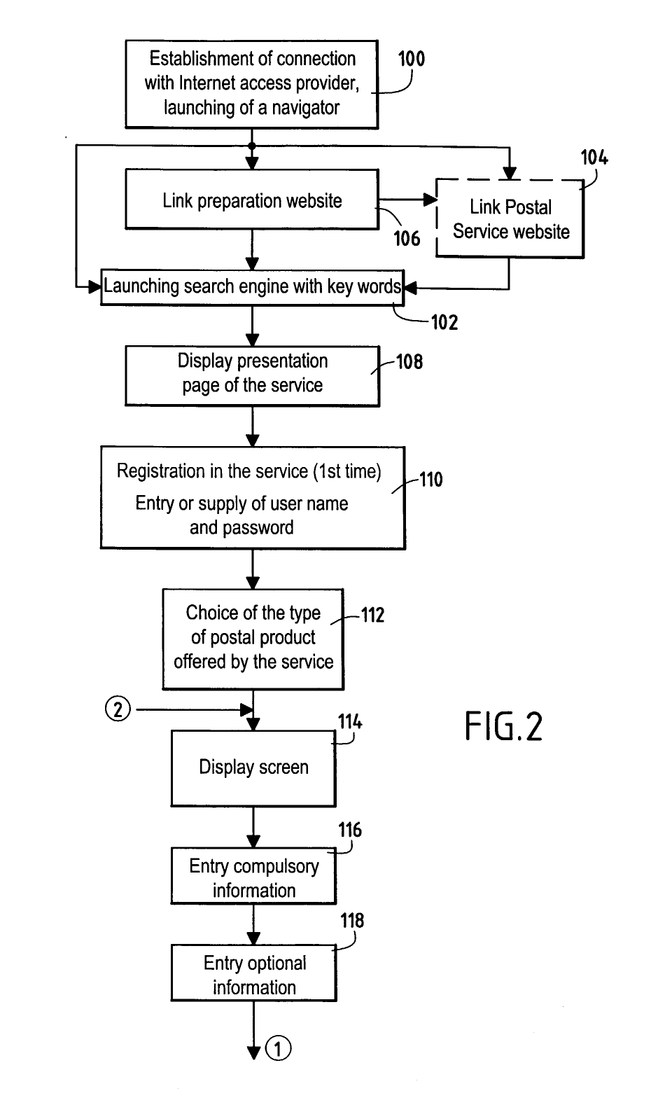

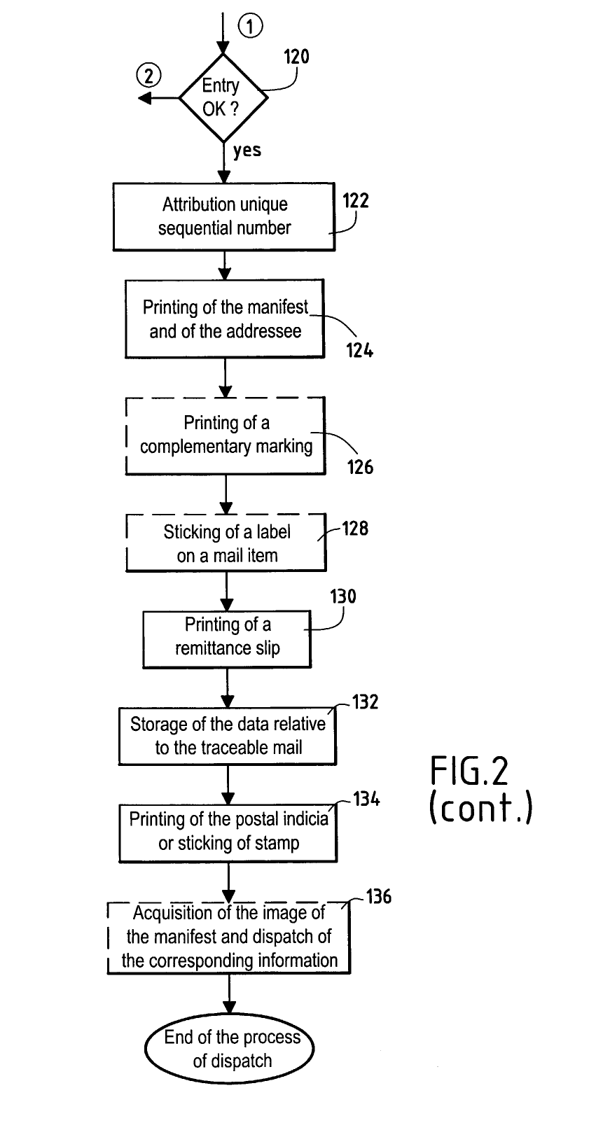

The process of preparing mail items according to the invention will now be described partly with reference to FIG. 2 which shows the different steps thereof.

The purpose of this process is to associate with certain mail items a tracing mechanism founded on the affixing on this mail item of graphics representative of the service requested by the user. Such graphics comprise a bar code of which the unique sequential number will allow the mail item to be traced all along its path from the sender to the addressee. This novel mail tracing service accessible through the Internet network comes in the form of three distinct postal products (the traceable letter, the traceable registered letter and the traceable registered letter with return receipt) of which the differences originate essentially from the operations effected by the agents of the Postal Service when the mail item is remitted to its addressee, although the process of dispatch of these three products (i.e. up to remittance in an establishment of the Postal Service for deposit) is identical. The traceable registered letter with return receipt in effect involves a signature by the addressee when it is remitted (with possible payment on delivery), unlike the traceable letter and the traceable registered letter which may be delivered without this signature. In addition, the traceable letter does not benefit from the guarantee of insurance associated with the rates of registration of the traceable registered letters.

The first step 100 of the process of the invention therefore consists for the user in establishing a connection with its Internet access provider and then launching its navigator or directly launching this Internet navigator if this user has a permanent connection to the Internet network (cabled link for example). Then, and depending on how well the user knows the Internet network, it may choose to access the home page of the Internet site of the third party in charge of preparing the mail items which may be the distributor of its franking machine (step 102), or, when the Postal Service has a server linked to the Internet network (case of the architecture of FIG. 1B), to that of the Internet site of the Postal Service (step 104), or launch the search engine integrated in its navigator (step 106) from key words such as “traceable letter” or “registered letter” for example. The entry of these key words, according to the indexation made by the search engine, will return the user towards the site of the Postal Service, or preferably directly towards the site of preparation. In the first case (access to the site of the Postal Service), and possibly after replying to a quick questionnaire, the user is directly routed towards the home page of the site of the third party (advantageously the distributor) which, among other services, includes the requested service.

The selection of the service, in a new step 108, leads to the display of a general presentation page of the service which then offers the user access to several functionalities depending on the choices that it will have to make and which are detailed hereinafter. However, previously, in a step 110, it must register in the service, communicating different information concerning it and necessary for the management of the service, particularly an address for correspondence (compulsory in order to inform it of the tracing of its mail), preferably an electronic address, and the identification number of its franking machine (if it has such a machine), against which it will receive a user name and a password to use during subsequent connections and giving it direct access to a personal page of the preparation website relative to its account of the mail tracing service.

In a step 112, the user must firstly choose the type of traceable mail which it desires to use (traceable letter, traceable registered letter or traceable registered letter with return receipt) by selecting it on a screen, and, depending on the choice made, it is proposed to define the registration rate and the type of payment (payment on delivery for example) before proceeding, in two successive steps 114 and 116, with the entry of the compulsory and optional information necessary for this dispatch. Compulsory information is essentially understood to mean the name and address of the addressee. Optional information is essentially understood to mean the sender's internal reference (the postal coordinates of the sender corresponding to the holder of the account being predefined at the level of this screen). Such entry may be effected directly by typing on the keyboard or with reference to a pre-established list of addressees or senders (drop-down menu of an address book) and available in a data base of the server of the identified third party 16 or preferably locally in a local data base of the computer terminal 12. Each new addressee may be automatically integrated in the address book by selecting on the screen a corresponding registration menu (optional step 1118). When the entry is terminated (step 120) and validated by the preparing server (which may verify for example the coherence of the postal codes entered or that of a registration rate with the type of mail selected), the latter attributes in a following step 122 a unique traceable mail number corresponding to the desired dispatch and allowing it to be traced during its path towards the addressee. This unique sequential number may be composed of a fixed first part corresponding for example to the identification number of the user's franking machine (which will have been communicated during step 110) and of a second sequential part incrementing by one unit for every new traceable mail. When the user is an individual not having a franking machine, this unique sequential number is essentially reduced to its sequential part, its fixed part being able to be composed of the letters WWW for example.

All the elements necessary for a complete edit now being gathered together, the user is then invited in a following step 124 to proceed with the print, via the standard printer 14, both of the graphics which the inventor calls “manifest”, corresponding to the traceable mail service requested and of the indication of the addressee (possibly also that of the sender particularly in the case of a dispatch with return receipt), this overall print of the descriptive identification elements (manifest +address) being able to be effected conventionally either directly on an envelope or on a label, depending on the mode of supply of the printer. In a variant embodiment, the print may also be made on plain paper (for example format A4), this choice being rendered possible by the presence on the screen of a specific print menu. In effect, in this mode of printing, it is necessary also to print on the A4 sheet complementary marks (for example step 126 for printing dotted lines) for indicating to the user a precise zone of cut-out around the descriptive elements. In the mode of print on label or on plain paper, the label or the paper is, of course, then stuck on the envelope or the packet to be dispatched (step 128). This first print may be immediately followed by a second, relative to the printing of a print report (acting as remittance slip) mentioning all the information necessary for identifying the shipment and, at minimum, the unique traceable mail number allocated to that shipment, the date of dispatch and the addressee (step 130). However, a remittance slip is preferably edited not for one but for a plurality of traceable postal matter. In these modes of print, the information of the manifest associated with the indications of the addressee and possibly of the sender are preferably stored in the local data base, but it may also be envisaged to store it in the data base of the remote server 16 (step 132) and even preferable when the user's computer terminal has little memory space available (portable computer or PDA for example).

The manifest and the remittance slip printed, the user may now proceed with the print of the postal indicia proper in the franking machine 20, directly on the envelope or on a label which will then be stuck on the envelope or parcel to be dispatched. Of course, such print will take into account the weight of the mail item to be sent (furnished by the scales linked thereto or integrated therein) and the type of traceable mail chosen by the user and previously informed on the franking machine. It will be noted that, when the user is an individual not having a franking machine, this step of the process of dispatch may be replaced by the simple adhesion of a postal stamp on the envelope or parcel to be dispatched at the place where the postal indicia is usually printed. Such individual may also go to a mail deposit establishment of the Postal Service to remit his envelope which will then be franked by an agent of that administration.

According to the invention, the differentiation of the prints of the manifest and of the postal indicia, the former on the standard printer 14 and the latter on the franking machine 20, makes it possible to avoid any loss of value for the user in the event of the print of the manifest being defective, which may be the case when such print is effected by any one and not by a specialized person employed in a mailing department. As the manifest does not have any monetary value (unlike the postal indicia), print thereof may be restarted on the standard printer as often as necessary until a sufficient quality of print is obtained to allow subsequent automatic reading of the manifest by conventional image acquisition means of scanner, digital camera or code reader type in the Postal Service's possession.

It will be noted that, where the franking machine 20 comprises image acquisition means 20b and is linked by a specialized line 22 to the distributor's server 24, it is possible to address to this distributor directly, via this specialized line, the information borne by the manifest (which is also postal data) and corresponding to the dispatch effected. In this way, the Postal Service may be informed by the distributor of the emission of traceable mail (via the link between servers 24 and 28b) and it may therefore prepare for its processing even before it is received. In effect, when the data are stored locally on the terminal 12 and in the absence of this prior information, the Postal Service can only know about the traceable mail when it is remitted by the user in one of its mail deposit establishments. In effect, it is only at that instant that the agent in charge of receiving the deposited mail can proceed, by automatic reading means of the afore-mentioned type, with the acquisition of the information of the manifest and that of the coordinates of the addressee and sender of the traceable mail. Such acquisition is accompanied at the same time as the computer editing of a deposit receipt (proof of deposit) which may be addressed to the sender (preferably by e-mail) or simply left at its disposal on the Postal Service server where it may be consulted. When there is a link between the server of the Postal Service and the server of the distributor, this receipt is preferably available directly on the personal account of the sender and therefore accessible by the Internet network. At the close of the process of dispatch, the traceable mail is remitted to the addressee by an agent of the Postal Service who then informs the Postal Service server (for example by means of a portable acquisition device) as to the date of presentation. If such presentation is not possible, an advice slip is left for the addressee who can collect his mail from the establishment of the Postal Service designated on said slip and which will inform as to the date of remittance of the mail when the latter will finally have been remitted to its addressee. In the particular cases where delivery cannot take place due to an incomplete address or the non-identification of the addresee at the address indicated, a code indicating this event is informed, together with the date. Such service information concerning the tracing of the mail items, like the preceding information available on the Postal Service server, may also be available on the distributor's server, the two servers being in relation through the Internet network (case of FIG. 1B) or on that of the third party in charge of preparing the mail (16) through the Postal Service servers (case of FIG. 1A).

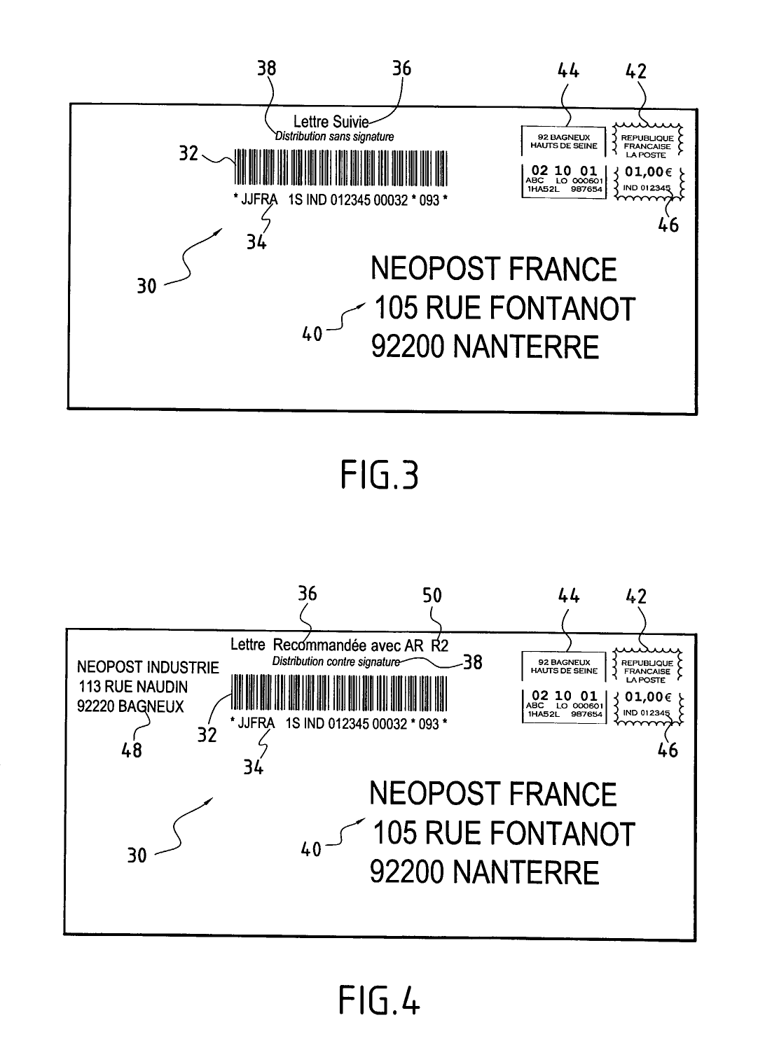

FIG. 3 shows a first example of a mail item bearing a manifest and postal indicia elaborated in accordance with the process described hereinbefore. The manifest 30 illustrated corresponds to the dispatch of a traceable letter. It comprises a bar code 32 and its clear wording 34 which correspond to the unique sequential number of the traceable mail, an indication of the postal product of the traceable mail service (in the present case a traceable letter 36) which allows a rapid distinction of the service requested upon deposit and delivery of the mail by the Postal Service, and an indication of the mode of delivery (in the present case delivery without signature of the addressee 38) which reminds the delivery agent of the Postal Service of the operations to be effected upon remittance to the addressee. The mail item also conventionally comprises the indication of the addressee 40 and the postal indicia with the reproduction of the postal stamp 42 and its date stamp 44. The correspondence between the number of the franking machine 46 and a fixed part of the unique sequential number IND 012345 will be noted.

A second example of a mail item bearing a manifest corresponding to the dispatch of a traceable registered letter with return receipt and postal indicia elaborated in accordance with the process described hereinbefore, is illustrated in FIG. 4.

As in the preceding example, the manifest comprises the bar code 32 and its clear wording 34 which correspond to the unique sequential number of the traceable mail, an indication of the postal product of the traceable mail service (in the present case traceable registered letter with return receipt) for a rapid distinction of the service requested upon deposit and delivery of the mail by the Postal Service, and an indication of the mode of delivery (in the present case delivery against signature of the addressee 38) which reminds the delivery agent of the Postal Service of the operations to be made during remittance to the addressee. The mail item also comprises the indication of the addressee 40 and the postal indicia with postal stamp 42 and date stamp 44. However, in addition to the previous indications, this mail item comprises in its upper left-hand part an indication of the sender 48 and, in the manifest next to the indication of the postal product, the indication of a rate of registration 50 (in the present case rate “R2”). It will be noted that an indication “payment on delivery” might also appear, if necessary.

Thus, the mail preparation system and associated process according to the invention allow perfect tracing of the mail items with a possibility for the user to be informed when it is delivered by consulting its personal page relative to the mail tracing service on the preparation website (preferably that of its distributor) and accessible via its user name and password. In addition, such consultation may also be made by the Internet network at any instant and any place, from any computer terminal connected to the network (including a portable communication terminal such as a WAP, GPRS or UMTS mobile telephone).

What is claimed is:

1. System for preparing mail items comprising both postal indicia constituting a monetary value and a service marking representative of a service associated with this mail item and previously requested by a user of this system, wherein it comprises first standard print means for printing the service marking and second secured print means for printing the postal indicia.

2. The system for preparing mail items of claim 1, wherein said first standard print means are constituted by a standard printer connected to a computer terminal of the user.

3. The system for preparing mail items of claim 2, wherein said computer terminal is linked, through an Internet network, to a server housing the website of an identified third party in charge of preparing the mail items.

4. The system for preparing mail items of claim 3, wherein said website is the website of a franking machine distributor.

5. The system for preparing mail items of claim 3, wherein said computer terminal comprises data acquisition means for entering determined information relative to the mail item benefitting from the service requested, and in particular the postal coordinates of the addressee of this mail item.

6. The system for preparing mail items of claim 5, wherein said server comprises means for attributing a unique sequential number to the mail item benefitting from the service requested, as a function of said determined information entered in said computer terminal.

7. The system for preparing mail items of claim 6, wherein it further comprises data storage means shifted to the level of said server to memorize said determined information collected at said computer terminal and said unique sequential number attributed by said server, these storage means being accessible from said computer terminal and from a server of the Postal Service.

8. The system for preparing mail items of claim 7, wherein said storage means comprise means for memorizing determined data relative to the delivery of the mail item by the Postal Service and received from said Postal Service server.

9. The system for preparing mail items of claim 1, wherein said second secured print means are constituted by a franking machine.

10. The system for preparing mail items of claim 9, wherein said franking machine is linked to a server of the distributor of said franking machine via a specialized communication line.

11. Process for preparing mail items comprising both postal indicia constituting a monetary value and a service marking representative of a service associated with this mail item and previously requested by a user, wherein the service marking is printed independently of the postal indicia.

12. The process for preparing mail items of claim 11, wherein the service marking is printed jointly with the indication of the postal coordinates of the addressee of the mail item, by means of a standard printer linked to a computer terminal.

13. The process for preparing mail items of claim 11, wherein the service marking is printed jointly with the indication of the postal coordinates of the sender of the mail item, by means of a standard printer linked to a computer terminal.

14. The process for preparing mail items of claim 11, wherein the service marking is printed by means of a standard printer linked to a computer terminal of a user, on a label intended to be stuck thereafter on the mail item.

15. The process for preparing mail items of claim 11, wherein determined information necessary for dispatch of the mail item benefitting from the service requested, and in particular the postal coordinates of the addressee of this mail item, are entered in a user's computer terminal.

16. The process for preparing mail items of claim 15, wherein the service marking includes a unique sequential number delivered by a server housing the website of the identified third party in charge of preparing the mail items as a function of said determined information entered in said computer terminal.

17. The process for preparing mail items of claim 16, wherein said determined information and said unique sequential number are memorized in storage means of said server and accessible from said computer terminal.

18. The process for preparing mail items of claim 12, wherein it further includes the print of a remittance slip by means of said standard printer.

19. The process for preparing mail items of claim 11, wherein said postal indicia are printed by a franking machine after the service marking has been printed.

20. The process for preparing mail items comprising both postal indicia constituting a monetary value and a service marking representative of a service associated with a determined mail item, wherein said process comprises the following steps:
a) establishment of a link with the Internet network from a computer terminal of a user,
b) access to a server housing the website of an identified third party in charge of preparing the mail items,
c) consultation at the user's computer terminal of a general presentation page of said website of the identified third party relative to said service,
d) upon first access to said service, supply by said server of the identified third party of a user name and a password in exchange for the communication by the user of determined information,
e) during subsequent accesses to said service, entry in the user's computer terminal of the user name and password received upon said first access,
f) display at the user's computer terminal of a personal presentation page relative to said service and specific to the user,
g) selection at the user's computer terminal of a postal product proposed on said personal presentation page from those of the group including the traceable letter, the traceable registered letter and traceable registered letter with return receipt,
h) display at the user's computer terminal of an entry screen relative to the postal product selected,
i) entry at the user's computer terminal of determined information necessary for dispatching a mail item,
j) attribution by the server of the identified third party of a unique sequential number associated with the mail item to be dispatched, and
k) printing, by a standard printer linked to said computer terminal, of the service marking incorporating said unique sequential number and an identifier of the postal product selected.

21. The process for preparation of claim 20, wherein it further includes a step of franking the mail item.

22. The process for preparation of claim 21, wherein the step of franking of the mail item consists in the printing of the postal indicia by a franking machine.

23. The process for preparation of claim 20, wherein said website of an identified third party in charge of preparing the mail items is the website of a distributor of franking machines.

24. The process for preparation of claim 23, wherein the step of access to the website of the franking machine distributor is effected via a website of the Postal Service.

25. The process for preparation of claim 20, wherein the step of communication of determined information comprises the communication of the postal coordinates of the user, including an electronic address.

26. The process for preparation of claim 20, wherein the step of communication of determined information comprises the communication of a franking machine identification number from which said unique sequential number is established.

27. System for preparing mail items comprising both a postal mark constituting a monetary value and a service marking representative of a service associated with this mail item and previously requested by a user of this system, wherein it comprises first standard printing means connected to a computer terminal of a user itself linked, through an Internet network, to a server housing the website of a third party in charge of preparing the mail items, in order to print both the postal coordinates of the addressee and the service marking.
